(19) United States
(12) Patent Application Publication
(10) Pub. No.: US 2006/0215743 A1
(43) Pub. Date: Sep. 28, 2006

(54) Property detection (formal verification) for a mixed system of analog and digital subsystems

(76) Inventors: Christian Lang, Garnstaedt (DE); Roland Syba, Bienstaedt (DE)

Correspondence Address: DUANE MORRIS, LLP;IP DEPARTMENT, 30 SOUTH 17TH STREET, PHILADELPHIA, PA, 19103-4196, US

(21) Appl. No.: 10/544,776

(22) PCT Filed: Feb. 5, 2004
(86) PCT No.: PCT/DE04/00193

§ 371 Date: Mar. 13, 2006

(30) Foreign Application Priority Data
Feb. 5, 2003 (DE) 103 04 569.4

(51) Int. Cl. H04B 17/00

(52) U.S. Cl. 375/224

(57) ABSTRACT

The invention relates to a method for detecting properties of a digital-analog mixed signal system (1) by formally verifying a digital substitution system (20). Component parameters and environment parameters are depicted as additional signals in the digital substitution model (substitution model, 20) for the analog components, and the analog part of the system is divided (90) into time-independent and linear time-dependent subsystems. The time-independent subsystems are regarded as stateless and are converted by combinatorial logic and the linear time-dependent subsystems for time-discretization while being substituted by finite automations. Despite the digitizing errors, it is possible to reliably draw conclusions about the original system from the verification results of the substitution model. The properties of the digital-analog mixed signal system (1) that are to be detected are enhanced for the analog components in such a manner that, in all occurring values of digitizing errors, these properties in the digital substitution model are only fulfilled once the digital-analog mixed signal system (1) also fulfills these properties by limiting (92) the permitted range of values for analog signals is limited (92) to twice the amount of the maximum digitizing error.

The invention relates to a method for the detection of properties of technical systems having digital and analog components. To this end, a “formal verification” is used.

A rigorous detection of properties of complex systems having analog components is usually not feasible. The well-known method for simulating analog-digital mixed-signal systems is very time consuming and may, therefore, be realized for only few states of the system. An assessment with regard to the behavior of the system in the non-simulated states may not be given. For systems that are exclusively composed of digital components, formal verification and, in particular, model checking, is a method for detecting properties with mathematical accuracy, cf. Bormann, “Formal Verification Becomes a Tool” 4.GI/ITG/GMM-Workshop, Methods and Descriptive Languages for Modeling and Verification of Circuits and Systems, Meissen, Feb. 2001, pages 9, 10 and WO-A99/50766 (Bormann, Siemens Corporation).

To date, however, this method is not applicable to analog components. For the verification of analog-digital mixed-signal systems, which also include analog components, the substitution of the analog original systems (components) by digital substitution models have been proposed (cf. Lang, “Verification of Mixed-Signal Circuits in the Automative Industry,” Conference in Dresden, Circuits and System Design, Dresden, Mar. 2002, pages 215 to 30, Fund Project 03M305D, BMBF. In practice, the application of this method brings about certain problems.
1. When replacing the analog original systems by digital substitution models, modifications in the systems' behavior are unavoidable, thereby no longer allowing the verification results of the digital substitution models to be used for an immediate statement regarding the properties of the analog original systems, cf. Chuang/Harrison “Analog Behavioral Modeling . . . ” IEEE Colloquium on Mixed Mode Modeling, London, 1994, pages 1 to 5.
2. The parameters of analog real systems are subjected to fabrication induced variations, which may not directly be represented by the digital substitution models.
3. Dynamic effects of the analog systems will not be represented by the digital substitution system.

It is an object of the invention to provide a generally applicable method for model checking of analog-digital mixed-signal systems. To this end, a simplified detection of properties of an analog-digital mixed-signal system (digital and analog components) is to be obtained by means of a model-like substitution system (model).

The method of the present invention (claims 1 or 5) for the detection of properties of a (technical) analog-digital mixed-signal system has the advantage, compared to the prior art, that despite a changed system behavior (previously mentioned Item 1), a reliable conclusion with respect to the properties of the mixed-signal system is possible on the basis of the properties of the substitution system. Variations of parameters of the analog systems, as well as their dynamic aspects are taken into consideration. The substitution system is characterized by:
the possibility of modeling of variable parameters of the analog components.
a division (grouping) of the system in time independent and time dependent linear subsystems.
a time discretization of the time dependent systems.
a quantization of the analog signals.
an error consideration.

The aforementioned properties of the mixed-signal systems will be understood by the person skilled in the field of formal verification in that these properties are mathematical theorems consisting of assumptions and statements. The assumptions restrict the possible values of the logic signals in the description of the system's behavior. The assumptions or conditions include values, which are taken on by the signals whenever the conditions or assumptions are fulfilled. A “property” is, thus, not an arbitrary property, but is to be considered in the context of a property of the circuit to be tested as relating to its switching or operating behavior. In other words, the property is also a description of the behavior, which, for mixed-signal systems, also takes into consideration the interaction of analog and digital circuit parts (components); these components are also verified, wherein the analog components are replaced by the digital models.

A digital substitution model represent the analog circuits, as is already described in the prior art (cf. Lang, same reference as above, page 26, upper portion, and page 27, second paragraph).

The parameters for the analog components (device parameters and environmental parameters) are also mapped into the digital substitution model. The analog components are grouped such that each group forms a time independent system or a time dependent system. These groups are treated differently. One of them is stateless and is substituted by a combinatorial logic. The other group is replaced by finite automations. Both groups are mapped into digital substitution systems. There may be provided one or more groups from the respective type (claim 5).

Digitizing errors may be assumed, nevertheless, a reliable conclusion from the results of the verification of the described substitution model with respect to the original system is obtained. The original system is the real system having the analog and digital components.

The “properties to be detected” are also the predetermined properties to be detected, which are, however, also given in advance as properties that correspond to the described mathematical theorems (assumptions and statement). The properties to be detected of the mixed-signal system are enhanced. An enhancement is a reduction of the permitted value range of the analog signals.

Preferably, an amount twice the maximum digitizing error is provided, which determines the enhancement.

Thus, three models exist: the reference model (the original or the property to be verified); the substitution model, which is verified and which also comprises properties that are compared to the aforementioned “(predetermined) properties to be verified”; and an enhanced reference model. Moreover, the mixed-signal system is provided (real analog system or analog real system), which has real properties that desirably match the properties of the substitution model as closely as possible.

The present invention will be described by means of exemplary embodiments, wherein it should be appreciated that the following discussion is the description of preferred examples of the invention.

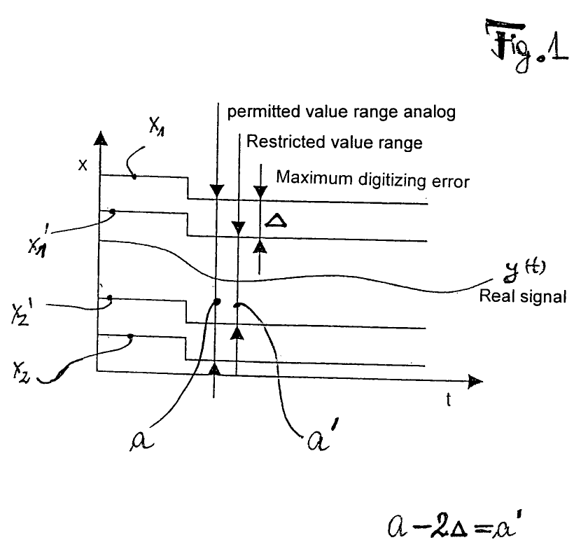

FIG. 1 illustrates functions, wherein the permitted value range a for analog signals is restricted to a′ by two times the maximum digitizing error Δ.

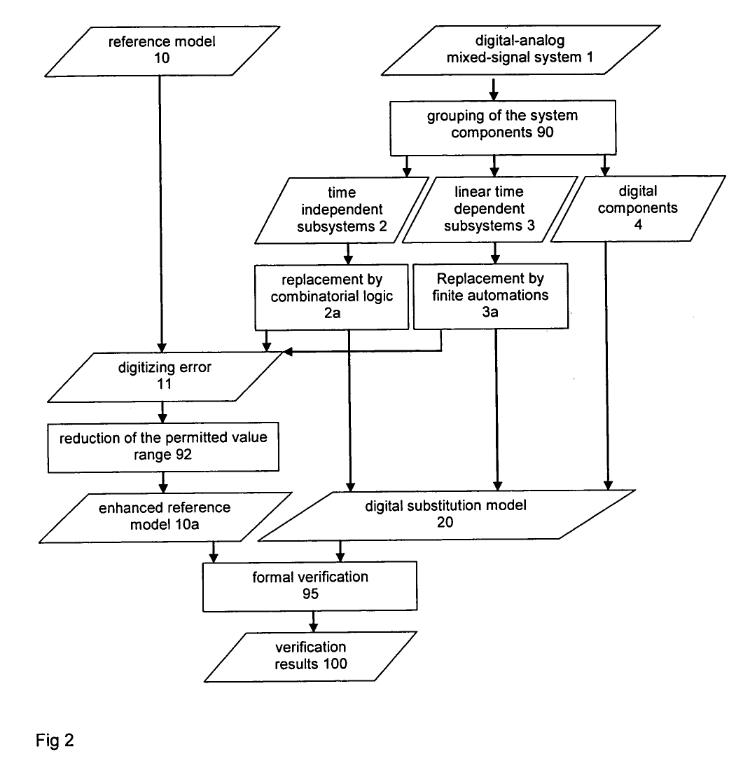

FIG. 2 illustrates a reference model 10 and a digital-analog mixed-signal system 1.

The starting point of the described method is a reference model 10 and a digital-analog mixed-signal system 1, as is symbolically illustrated in FIG. 2. The digital-analog mixed-signal system 1 is a technical system, preferably an electronic circuit, comprising inputs and outputs and being composed of analog and digital components. The reference model 10 is a sum of properties.

A “property” defines a given signal sequence (or: to be verified) at the outputs of the digital-analog mixed-signal system 1 upon a specific sequence of signals at the inputs.

The goal of the method is the verification result 100 that specifies whether the property of the reference model 10 in the digital-analog mixed-signal system 1 is fulfilled. A fulfillment represents a (positive) verification.

Since a direct verification of the reference model 10 with respect to the digital-analog mixed-signal system 1 is not feasible according to the prior art, the digital-analog mixed-signal system is mapped into a digital substitution model 20. During the method, the analog components of the digital-analog mixed-signal system 1 are grouped into time independent subsystems 2 and/or into (linear) time dependent subsystems 3 (functionally divided or classified) according to Step 90. These subsystems are replaced by a combinatorial logic 2A and by finite automations 3A, respectively, which are not shown in the figures. The subsystems 2, 3 that are digitized in this manner form the digital substitution model 20 along with the digital components 4 of the digital-analog mixed-system.

Due to the replacement of the analog components by the combinatorial logic and the finite automations performed during the course of the verification, a change of the behavior of the system is unavoidable. This change is referred to as digitizing error 11. In order to obtain a reliable assessment of the digital-analog mixed-signal system 1 despite the digitizing error, properties described in the reference model 10 are enhanced in method step 92, for instance, by restricting the permitted value range of the signals described by the properties, as is shown in FIG. 1. The results of this enhancement 92 is an enhanced reference model 10a.

The enhanced model 10a is compared or verified with respect to the digital substitution model by means of the known methods 95 of “the formal verification” (cf. Bormann, “Formal Verification Becomes A Tool,” see the above reference, and WO-A 99/50766 (Bormann, Siemens Corporation).

The result of the verification is the verification result 100. By means of the above-described method, it is insured that the verification result indicates whether the properties of the reference model 10 are met in the digital-analog mixed-signal system upon application of the enhanced model 10A, instead of the regular property description by means of the reference model 10.

A substitution system 20 is characterized by:
the division of the system into time independent and time dependent linear subsystems 2, 3.
the time discretization of the time dependent systems.
the quantization of the analog signals.
an error consideration 11.

Modeling of variable parameters of the analog components is possible. For the treatment of parameter variations of analog components, additional signals are introduced into the digital substitution models. These additional signals model the variable parameters of the analog system, such as offset voltages, resistance values or device temperatures. The effect of the variable parameters is resembled by corresponding mathematical functions in the digital substitution model 20. The properties of the digital substitution model to be detected are now completed by a permitted (valid) variance of the variable parameters. A formal detection of properties for the digital substitution model 20 thus results in the automatic detection of the corresponding property for the analog-digital mixed-signal system 1 across the entire variance of the respective parameter.

Dividing the System into Time Independent and Time Dependent (Linear) Subsystems:

In order to properly map the dynamic properties of the analog original system 1 into the digital substitution system 20, the original system is divided into time independent and time dependent subsystems at step 90.

The time independent subsystems 2 are characterized in that all dynamic transient processes have died down within one single clock period of the digital substitution model 20. These subsystems may be considered as stateless and are modeled by combinatorial logic. Moreover, the digitizing of such non-linearly formed systems may readily be performed by means of corresponding numerical approximations. These may also be linear or non-linear.

For time dependent systems 3, dynamic transient processes are effective over a plurality of clock periods of the digital substitution model 20. These systems may be mapped into the substitution model by finite automations 3A. A consistent theory is available for linear analog systems so as to digitize these systems. For such time dependent systems that are non-linear, an approach is selected, in which these systems are linearized, for instance, in the vicinity of a working point, or these systems may be divided into non-linear time independent systems (for instance, limiter) and into linear time dependent systems. Again, both types of systems, linear and non-linear, are possible.

Time Discretization of the Time Dependent Systems:

Appropriate substitution models have to be found for the time dependent systems (for instance, linear systems). For this approximation, well known algorithms available from the control technique may be used, for instance, the bi-linear transformation, which maps the analog system into a finite automation (for instance, IIR or FIR digital filters), cf. Phillips, Nagle “Digital Control System Analysis and Design”, Prentiss Hall, Second Edition, 1990.

An error of the time discretization may be determined from the comparison of the frequency behavior of the analog original system 1 and the digital substitution model. By correspondingly selecting a clock frequency of the digital substitution model 20, the error of the time discretization may be reduced.

Quantization of the Analog Signals:

Since the digital substitution system may represent numerical values only with a finite precision, a so-called quantization error is generated with respect to the analog original system. This error is affected by the word length (that is, the number of bits of a data word) with which an analog signal is represented. The word length is a compromise. A long word length results in a high verification precision, but also in a long verification time period. For a short word length, the situation is inverted.

Error Consideration:

The replacement of the analog components in the digitized substitution model 20 is associated with errors, for instance, due to a quantization of the analog signals or of the time discretization. For this reason, properties in the digital substitution may be fulfilled, although the analog original system may not meet the corresponding property. This case is referred to as “falls positive” and renders the verification result 100 useless.

If properties to be detected (as an assumption of the reference model 10) for the mixed-signal system having analog components are enhanced such that for all occurring values of the digitizing errors these given properties are fulfilled in the digital substitution model 20, then the analog-digital mixed-signal system 1 will also meet these properties. This may be accomplished by restricting the valid or permitted value range “a” for analog signals y(t) by (at least) the amount 2Δ of the maximum digitizing error Δ (cf. FIG. 1). Thus, an enhanced property a′ is obtained in the form of a-2Δ.

This restriction may have the effect that certain digital substitution models may not fulfill certain properties, although the corresponding properties are fulfilled in the analog-digital mixed-signal system. This case will be referred to as “falls negative.” The digitizing error is reduced by an enhanced precision during the digitizing of the analog-digital mixed-signal system. This may be accomplished, among others, by a more accurate quantization of the analog signals or by an increased clock frequency of the substitution model 20. In this way, the permitted value range no longer needs to be so extensively restricted. The precision of the digitizing may be increased until the verification of the digital substitution model and, thus, of the original system, is successful, or until it is guaranteed that the original system fails to meet the property under consideration. In the former case, the verification was successful, in the latter case, the original system does not meet the specification.

1. A method for detecting a property of a digital-analog mixed-signal system (1) by formal verification of a digital substitution system or model (20) characterized in that device parameters and environmental parameters for the analog components are represented as additional signals in the digital substitution model (substitution system; 20) and the analog part of the system is divided into time independent and linear time dependent subsystems (90), wherein the time independent subsystems may be considered as stateless and are replaced by combinatorial logic and wherein the linear time dependent subsystems are replaced by finite automations (2A, 3A) for time discretization and are mapped into the digital substitution model (20), and wherein despite the digitizing error it is possible to draw a reliable conclusion from the verification results of the substitution model with respect to the original system, that is, the properties to be detected of the digital-analog mixed-signal system (1) for the analog components are enhanced in such a way that for all occurring values of the digitizing error this property in the digital substitution model is fulfilled only when the digital-analog mixed-signal system (1) also fulfills this property, by restricting the permitted value range for analog signals by two times the maximum digitizing error (92).

2. The method for detecting properties of the digital-analog mixed-signal system according to claim 1, wherein the additional signals model variable parameters of the analog system, particularly offset voltages, resistance values or device temperatures.

3. The method of claim 1, wherein the time dependent non-linear systems are either linearized, especially in the vicinity of the working point, or the systems are divided in non-linear time independent systems, in particular, into limiters, and linear time dependent systems.

4. The method of claim 1, wherein an error of the time discretization is determined from a comparison of the frequency characteristics of the analog original system (1) and the digital substitution system (20) and that the error of the time discretization is reduced by the selection of the clock frequency of the digital substitution system.

5. A method for detecting or testing of properties of a digital-analog mixed-signal system (1) by formal verification (95) of a digital substitution model (20), comprising:
(i) mapping device parameters and environmental parameters for analog components of the mixed-signal system (1) into the digital substitution model (20),
(ii) grouping the analog components of the system (1) in at least one time independent subsystem (2) or at least one time dependent (3) subsystem;
(a) said time independent subsystem (group; 2) being regarded as stateless and being replaced by combinatorial logic;
(b) said time dependent subsystem (group; 3) being replaced by a finite automation for a time discretization; said subsystems being mapped into the digital substitution model (20);
(iii) wherein digitizing errors (11) do not prevent a reliable conclusion regarding the original system (1) from verification results (100) of the substitution model (20), wherein particularly properties to be detected of the digital-analog mixed-signal system (1)—predetermined properties of a reference model (10)—are enhanced (92, 10A) by restricting a permitted value range (a, a′) for analog signals (y(t)) by, particularly, at least two times the amount of the maximum digitizing error (Δ);
(iv) such that for all occurring values of digitizing errors the enhanced properties (A′) are verified as an enhanced reference model (10A) with respect to the digital substitution model (20), wherein the enhanced properties are fulfilled only when the digital-analog mixed-signal system (1) also fulfills the properties of the reference model (10).

6. The method of claim 5, wherein additional signals model variable parameters of the analog components, such as an offset voltage, a resistance value or a device temperature.

7. The method of claim 5, wherein at least one group of the time dependent groups (3) is non-linear.

8. The method of claim 7, wherein the non-linear group is linearized in particular in the vicinity of the working point.

9. The method of claim 7, wherein the non-linear group is divided into a non-linear time independent system and into a linear time dependent system.

10. The method of claim 5, wherein an error caused by a time discretization is determined from a comparison of frequency characteristics of the analog original system (1) and the digital substitution model (20), respectively, and wherein a clock frequency of the digital substitution model (20) is selected so as to reduce the error caused by the time discretization.

11. The method of claim 5, wherein a formal verification of the enhanced reference model (10a) with respect to the substitution model (20) is performed (95) so as to obtain at least one verification result (100).

12. A method for detecting or testing properties of a digital-analog mixed-signal system (1) by a formal verification (95) of a digital substitution model (20), comprising:
(i) mapping device parameters and environmental parameters for analog components of the mixed-signal system (1) into a digital substitution model (20);
(ii) grouping the analog components of the system (1) into at least one time independent subsystem (2) and at least one time dependent (3) subsystem;
(a) said time independent subsystem (group; 2) being considered as stateless and being replaced by a combinatorial logic;
(b) said time dependent subsystem (group; 3) being replaced by a finite automation for a time discretization; said subsystems being transferred into the digital substitution model (20);
(iii) wherein digitizing errors (11) do not prevent a reliable conclusion regarding the original system (1) from verification results (100) of the substitution model (20), wherein particularly properties to be detected of the digital-analog mixed-signal system (1)—predetermined properties of a reference model (10)—are enhanced (92, 10a) by restricting a permitted value range (a, a′) for analog signals (y(t)) by in particular at least twice the amount of the maximum digitizing error (Δ).
